(19) United States
(12) Patent Application Publication
(10) Pub. No.: US 2025/0273989 A1
(43) Pub. Date: Aug. 28, 2025

(54) METHOD AND SYSTEM FOR ALLOCATING HYBRID ENERGY STORAGE CAPACITY, ELECTRONIC DEVICE AND MEDIUM

(71) Applicant: NORTH CHINA ELECTRIC POWER UNIVERSITY, BEIJING (CN)

(72) Inventors: XIAOHE YAN, BEIJING (CN); NIAN LIU, BEIJING (CN); HAN GUO, BEIJING (CN)

(21) Appl. No.: 19/002,968

(22) Filed: Dec. 27, 2024

(30) Foreign Application Priority Data
Feb. 27, 2024 (CN) 202410210774.0

(51) Int. Cl. H02J 15/00; H02J 3/28; H02J 13/00

(52) U.S. Cl. CPC H02J 15/00; H02J 13/00002; H02J 3/28; H02J 2203/20

(57) ABSTRACT

A method for allocating hybrid energy storage capacity is provided, including: determining a curve of an SoC with a maximum utility of the hybrid energy storage system in a predetermined time period as an objective function, with an SoC constraint and ES charging and discharging constraints as constraint conditions according to an power service utility signal; extracting an SoC value and a time point corresponding to each extreme point in the curve of the SoC; calculating a difference between adjacent SoC values to obtain a mileage sequence; obtaining a plurality of cycle processes and a mileage corresponding to each cycle process; constructing a mathematical model of a relationship between the mileage and an utility loss; calculating a mileage of each energy storage in a corresponding cycle process by applying an equal consumed energy increase ratio principle according to the mathematical model.

### CROSS-REFERENCE TO RELATED APPLICATION

This patent application claims the benefit and priority of Chinese Patent Application No. 202410210774.0 filed with the China National Intellectual Property Administration on Feb. 27, 2024, the disclosure of which is incorporated by reference herein in its entirety as part of the present application.

### TECHNICAL FIELD

The present disclosure relates to the technical field of new energy, in particular to a method and a system for allocating hybrid energy storage capacity, an electronic device and a medium.

### BACKGROUND

The global demand for renewable energy resources is increasing gradually. It is estimated that by 2030, renewable energy will provide 45% to 50% of the electricity in the world. As a key component of promoting the penetration of renewable energy, it is estimated that the installed capacity for energy storage will increase from 4.8GW in 2022 to 387GW in 2030. However, the frequent charging and discharging of lithium ion energy storage significantly affects its service life. Therefore, it is necessary to use a hybrid energy storage system for cooperative control. With the development of a large-scale energy storage system, the integration of the hybrid energy storage with different storage characteristics has become the focus of this field. The frequency decomposition method is mainly used to identify power allocation points, so as to allocate power among various energy system (ES) units. In this field, empirical mode decomposition is often used to decompose the reference power of hybrid energy storage, followed by an improved moving average filter. Thereafter, its high-frequency and low-frequency components are reconstructed to determine an average cut-off frequency of energy storage and a bifurcation point on the power curve, so as to allocate the power of hybrid energy storage. However, there are still some limitations. 1) The frequency-based decomposition method mainly controls a frequency division point but does not control the power amplitude of energy storage units, which may result in the power output of each energy storage unit exceeding its upper limit of the charging power and the discharging power after power allocation. 2) The original method usually does not prevent different types of energy storage from charging and discharging at the same time, which violates the physical constraints of hybrid energy storage. 3) The selection of frequency division points in the exiting methods is somewhat subjective. These methods are based on mathematical tools rather than physical constraints, lacking the interpretability of the real physical world.

These shortcomings highlight the demand for more detailed control strategies, which take into account the physical characteristics and constraints of hybrid energy storage, so as to ensure the operation within safety limits, and maximize their efficiency and service life.

### SUMMARY

The present disclosure aims to provide a method and a system for allocating hybrid energy storage capacity, an electronic device and a medium, which can improve the overall working efficiency of the energy storage system.

In order to achieve the above objective, the present disclosure provides the following scheme: a method for allocating hybrid energy storage capacity. The allocating method includes:
acquiring a power service utility signal;
determining a curve of a state of charge (SoC) of a hybrid energy storage system with respect to time with a maximum utility of the hybrid energy storage system in a predetermined time period as an objective function, with an SoC constraint and energy system (ES) charging and discharging constraints as constraint conditions and according to the power service utility signal;
extracting an SoC value and a time point corresponding to each extreme point in the curve of the SoC of the hybrid energy storage system with respect to time to obtain a plurality of SoC values arranged in chronological order;
calculating a difference between two adjacent SoC values as a mileage, to obtain a mileage sequence, where the mileage sequence includes a plurality of mileages; the mileages are arranged in chronological order;
applying a sliding window algorithm according to the mileage sequence to obtain a plurality of cycle processes and a mileage of the hybrid energy storage system corresponding to each cycle process, where each cycle process includes a continuous charging process and discharging process;
constructing a mathematical model of a relationship between the mileage of the hybrid energy storage system corresponding to each cycle process and an utility loss of the hybrid energy storage system in the predetermined time period;
calculating a mileage of each energy storage of the hybrid energy storage system in a corresponding cycle process by applying a principle of an equal consumed energy increase ratio according to the mathematical model;
controlling each energy storage to charge or discharge according to the mileage of each energy storage in the corresponding cycle process.

The hybrid energy storage system includes at least one of power-type energy storage and energy-type energy storage. The power-type energy storage includes flywheel energy storage, electrochemical energy storage and so on. The electrochemical energy storage includes a lead-acid battery, a lithium battery, a fuel cell, supercapacitor and so on. The energy-type energy storage includes pumped storage, compressed air storage, gravity storage, large-scale battery storage, and so on.

In an embodiment, the predetermined time period is 24 hours.

In an embodiment, applying a sliding window algorithm according to the mileage sequence to obtain a plurality of cycle processes and a mileage corresponding to each cycle process includes: determining whether a value of an intermediate element in a fixed-length sliding window is less than a value of each adjacent element of the intermediate element, where the fixed-length sliding window contains three elements;
when the value of the intermediate element is less than the value of each adjacent element of the intermediate element, a time point corresponding to the intermediate element is an ending moment of a cycle process, a time point corresponding to a first element in the fixed-length sliding window is a starting moment of the cycle process, and the value of the intermediate element is set as the mileage corresponding to the cycle process.

In an embodiment, the objective function is:

$$max I = max {\sum }_{t = 1}^{24} {\sum }_{i = 1}^{n} {λ}_{i , t} ( {P}_{d , i , t} - {P}_{c , i , t} ) ;$$

the SoC constraint is: SoCₘᵢₙ≤SoCₜ≤SoCₘₐₓ; SoC(₂₄)=SoC₍₁₎.
the ES charging and discharging constraints are: P_{c min}≤P_{c,t}≤P_{c max};

$${P}_{dmin} \leq {P}_{d , t} \leq {P}_{dmax} ;$$

$$0 \leq {P}_{c , t} \leq {P}_{cmax} \times {A}_{E} ;$$

$$0 \leq {P}_{d , t} \leq {P}_{dmax} \times ( 1 - {A}_{E} ) ;$$

where SoC(t) is an SoC value of the energy storage system at moment t, SoC(1)=SoC(24) indicates that the SOC value of energy storage at a first moment in an operation day are equal to that at a last moment of the operation day; P_{c,t} is a discharging power of energy storage at moment t, P_{d,t} is a charging power of energy storage at moment t; P_{d,i,t} is a charging power of hybrid energy storage; P_{c,i,t} is a discharging power of hybrid energy storage; λ_{i,t} is a power service utility signal; SoCₘᵢₙ is a minimum value of the SoC; SoCₘₐₓ is a maximum value of the SoC; P_{c min} is a lower limit of the discharging power of the hybrid energy storage system; P_{c max} is an upper limit of the discharging power of the hybrid energy storage system; P_{d min} is a lower limit of the charging power of the hybrid energy storage system; P_{d max} is an upper limit of the charging power of the hybrid energy storage system; A_{E} is a binary variable; and I is a profit within 24 hours.

In an embodiment, the mathematical model is:

$${C}_{a} = {a}_{1}^{′} {M}_{a}^{n} + {a}_{2}^{′} {M}_{a}^{n - 1} + ⋯ + {a}_{n - 1}^{′} {M}_{a} + {a}_{n}^{′} ;$$

where Cₐ is a cost loss, Mₐⁿ is an n-th power of a mileage in stage a; a₁′ . . . aₙ′ are all coefficient constants.

A system for allocating hybrid energy storage capacity applies the method for allocating hybrid energy storage capacity, and the allocation system includes an acquisition module, a curve determining module, an extracting module, a first calculating module, a mileage determining module, a constructing module, a second calculating module and a control module.

The acquisition module is configured to acquire a power service utility signal.

The curve determining module is configured to determine a curve of a state of charge (SoC) of a hybrid energy storage system with respect to time with a maximum utility of the hybrid energy storage system in a predetermined time period as an objective function, with an SoC constraint and energy system (ES) charging and discharging constraints as constraint conditions and according to the power service utility signal.

The extracting module is configured to extract an SoC value and a time point corresponding to each extreme point in the curve of the SoC of the hybrid energy storage system with respect to time to obtain a plurality of SoC values arranged in chronological order.

The first calculating module is configured to calculate a difference between two adjacent SoC values as a mileage, to obtain a mileage sequence, where the mileage sequence includes a plurality of mileages; the mileages are arranged in chronological order.

The mileage determining module is configured to apply a sliding window algorithm according to the mileage sequence to obtain a plurality of cycle processes and a mileage of the hybrid energy storage system corresponding to each cycle process, where each cycle process includes a continuous charging and discharging process.

The constructing module is configured to construct a mathematical model of a relationship between the mileage of the hybrid energy storage system corresponding to each cycle process and a utility loss of the hybrid energy storage system in the predetermined time period.

The second calculating module is configured to calculate a mileage of each energy storage of the hybrid energy storage system in a corresponding cycle process by applying a principle of an equal consumed energy increase ratio according to the mathematical model.

The control module is configured to controlling each energy storage to charge or discharge according to the mileage of each energy storage in the corresponding cycle process.

An electronic device is provided, including a memory and a processor, where the memory is configured to store a computer program, and the processor executes the computer program to cause the electronic device to implement the method for allocating hybrid energy storage capacity.

A computer-readable storage medium is provided, where a computer program is stored therein, which, when executed by a processor, implements the method for allocating hybrid energy storage capacity.

According to the specific embodiment provided by the present disclosure, the present disclosure has the following technical effects. According to the present disclosure, an equal mileage incremental utility ratio method is used to solve the problem exceeding limit of the charging and discharging curve after frequency decomposition and charge-discharge of different types of energy storage systems at the same time. The traditional decomposition of the frequency of the charging and discharging curve into a high frequency and a low frequency is transformed into the problem of allocating mileages. By calculating the mileage of each energy storage in the corresponding cycle process in the hybrid energy storage system, the optimal allocated mileage of each energy storage is obtained, which improves the overall working efficiency of the energy storage system.

### BRIEF DESCRIPTION OF THE DRAWINGS

In order to explain the embodiments of the present disclosure or the technical schemes in the prior art more clearly, the drawings that need to be used in the embodiments will be briefly introduced. Obviously, the drawings in the following description are only some embodiments of the present disclosure. For those skilled in the art, other drawings can be obtained according to these drawings without creative labor.

FIG. 1 is a schematic block diagram of allocating hybrid energy storage capacity based on the equal mileage incremental utility ratio according to the present disclosure.

FIG. 2 is a flow chart of the practical application of a method for allocating hybrid energy storage capacity according to the present disclosure.

FIG. 3 is a flow chart of a method for allocating hybrid energy storage capacity according to the present disclosure.

### DETAILED DESCRIPTION OF THE EMBODIMENTS

The technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

The purpose of the present disclosure is to provide a method and a system for allocating hybrid energy storage capacity, an electronic device and a medium, which can improve the overall working efficiency of the energy storage system.

The present disclosure establishes a method for allocating mileages of hybrid energy storage based on the equal mileage incremental utility ratio method, through which the charging and discharging mileages and the utility of different units of hybrid energy storage can be determined. The present disclosure provides a more reasonable mileage counting method, which is used to calculate a data set of mileages M. First, a general regulation model of energy storage participating in power services is introduced. The optimal charging and discharging solution result and the SoC change curve are obtained by maximizing energy storage utility. Thereafter, the charging and discharging mileage model is introduced to define the selection rule of charging and discharging mileages M. Second, a mileage loss model based on life loss is established. A mathematical model between the cycle life N and utility C is determined, and then a relationship between the mileages M and the utility C is deduced through the relationship between the mileages M and the cycle life N. Finally, based on the relationship between the mileages M and the utility C, and according to the equal mileage incremental utility ratio, the optimal energy storage mileage allocation is solved and obtained, and then the results of allocating each energy storage charging and discharging capacity are fitted based on the optimal energy storage mileage allocation.

In order to make the above objects, features and advantages of the present disclosure more obvious and understandable, the present disclosure will be explained in further detail with reference to the drawings and detailed description hereinafter.

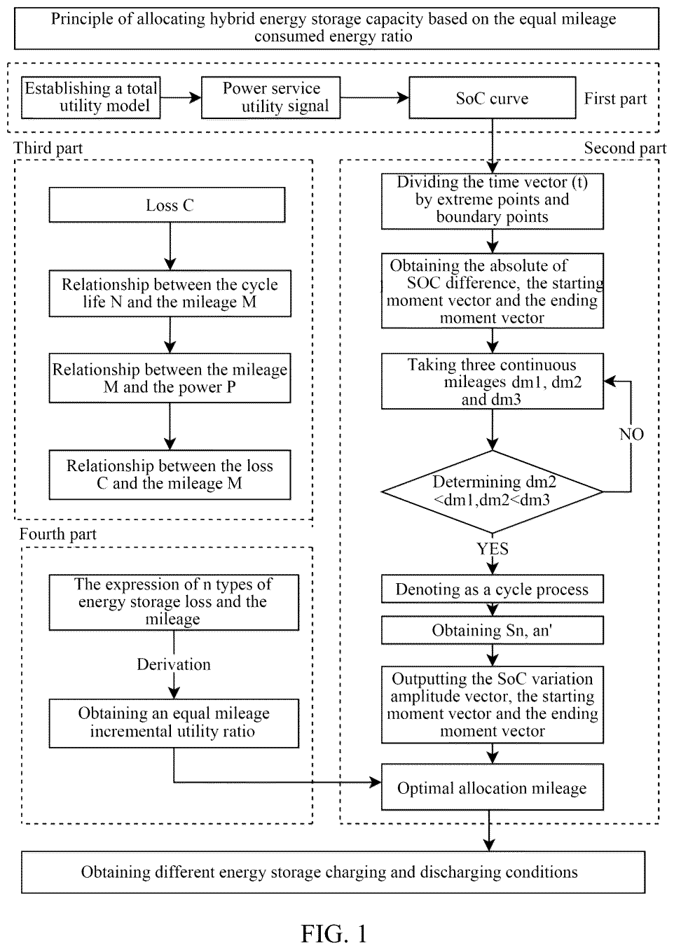

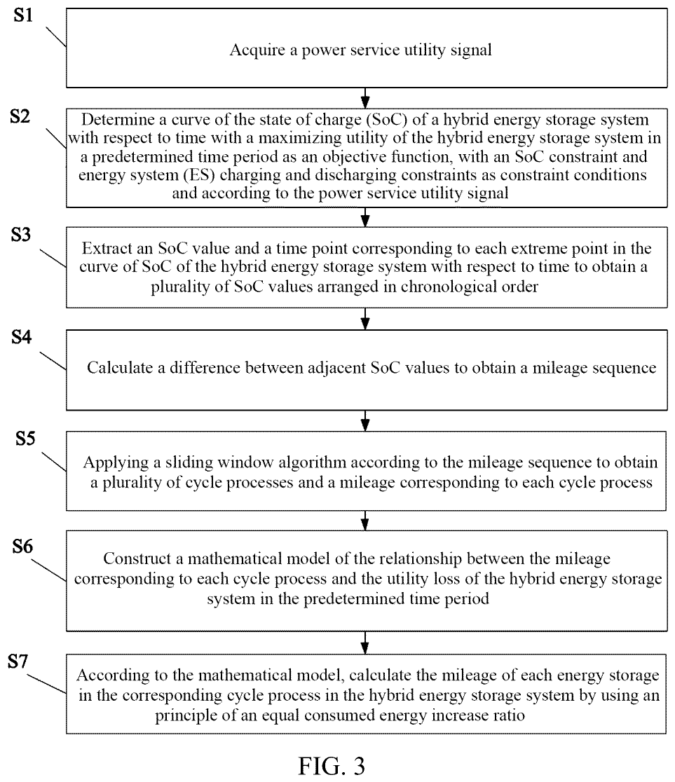

Embodiment 1: As shown in FIGS. 1 and 3, a method for allocating hybrid energy storage capacity according to the present disclosure includes Step S1 to Step S7.

Step S1: a power service utility signal is acquired.

In practical application, the power service utility signal is obtained according to a demand of power services. Optionally, the power service utility signal can be the current market price signal.

Step S2: a curve of the state of charge (SoC) of a hybrid energy storage system with respect to time is determined with a maximizing utility of the hybrid energy storage system in a predetermined time period as an objective function, with an SoC constraint and energy system (ES) charging and discharging constraints as constraint conditions and according to the power service utility signal.

In an embodiment, the predetermined time period is 24 hours.

In practical application, the hybrid energy storage model is established according to the objective function to obtain the optimal charging and discharging solution result and the SoC change curve. The energy storage regulation model is established with a goal of maximizing daily utility of the energy storage station within 24 hours.

When the hybrid energy storage station participates in power services, it is necessary to establish its total utility model first, which is obtained by the product of the charging and discharging of the hybrid energy storage station, the wind and photovoltaic power output and the power service utility signal.

$$max I = max {\sum }_{t = 1}^{24} {\sum }_{i = 1}^{n} {λ}_{i , t} ( {P}_{d , i , t} - {P}_{c , i , t} ) \qquad ( 1 )$$

where P_{d,i,t} and P_{c,i,t} are the charging power and the discharging power of hybrid energy storage, and λ_{i,t} is the power service utility signal.

In the process of energy storage regulation, in addition to maximizing utility as the objective function, the constraints such as the SoC constraint and the ES charging and discharging constraints need to be satisfied.

In an embodiment, the SoC constraint is:

$${SoC}_{min} \leq {SoC}_{t} \leq {SoC}_{max} ; \qquad ( 2 )$$

$${SoC}_{( 24 )} = {SoC}_{( 1 )} . \qquad ( 3 )$$

The charging and discharging constraints are:

$${P}_{cmin} \leq {P}_{c , t} \leq {P}_{cmax} ; \qquad ( 4 )$$

$${P}_{dmin} \leq {P}_{d , t} \leq {P}_{dmax} ; \qquad ( 5 )$$

$$0 \leq {P}_{c , t} \leq {P}_{cmax} \times {A}_{E} ; \qquad ( 6 )$$

$$0 \leq {P}_{d , t} \leq {P}_{dmax} \times ( 1 - {A}_{E} ) ; \qquad ( 7 )$$

where SoC(t) is an SoC value of the energy storage system at moment t, SoC(1)=SoC(24) indicates that the SOC value of energy storage at a first moment of an operation day is equal to that at a last moment of the operation day; P_{c,t} is a discharging power of energy storage at moment t, P_{d,t} is a charging power of energy storage at moment t; SoCₘᵢₙ and SoCₘₐₓ are the minimum limit and the maximum limit of the SoC, respectively. The equation (3) requires that the SoC value at the first moment of the operation day is equal to that at the last time of the operation day. The equation (4) and the equation (5) indicate the charging and discharging constraints of the energy storage system, respectively. The variables P_{c min}, P_{c max}, P_{d min} and P_{d max} denote the lower and upper limits of the charging and discharging power of the energy storage system, respectively. The equation (6) and the equation (7) constrain that the energy storage can only be in the state of charging or discharging at the same time, where A_{E} is a binary variable with a value of 0 or 1.

Then the charging and discharging curve of energy storage in one day is obtained, and then is converted into the overall SoC curve of energy storage according to the relationship between the SoC and charging and discharging.

$${SoC}_{t} = {SoC}_{t - 1} + {P}_{c} / {P}_{e} - {P}_{d} / {P}_{e} ; \qquad ( 8 )$$

where P_{c} indicates the charging power, P_{d} indicates the discharging power, and Pₑ indicates the total power of the system.

Step S3: an SoC value and a time point corresponding to each extreme point in the curve of SoC of the hybrid energy storage system with respect to time are extracted to obtain a plurality of SoC values arranged in chronological order.

Step S4: a difference between adjacent SoC values is calculated to obtain a mileage sequence, where the mileage sequence includes a plurality of mileages; the mileages are arranged in chronological order.

Step S5: a sliding window algorithm is applied according to the mileage sequence to obtain a plurality of cycle processes and a mileage corresponding to each cycle process, where each cycle process includes a continuous charging process and a discharging process.

The cycle process specifically includes: entering the discharging process after the charging process is finished, then entering a next cycle process, continuing to charge, and then discharging. Each cycle process includes a charging process and a discharging process, and the charging process and the discharging process are continuous.

Step S5 specifically includes Step S51 to Step S52.

Step S51: it is determined whether a value of an intermediate element in a fixed-length sliding window is less than a value of each adjacent element of the intermediate element, where the fixed-length sliding window contains three elements;
Step S52: when the value of the intermediate element is less than the value of each adjacent element of the intermediate element, a time point corresponding to the intermediate element is an ending moment of the cycle process, a time point corresponding to a first element in the fixed-length sliding window is a starting moment of the cycle process, and the value of the intermediate element is set as the mileage corresponding to the cycle process.

In practical application, the charging and discharging mileages are calculated based on the overall SoC change curve obtained from the hybrid energy storage system.

1) Mileage calculation: t=[t₁,t₂, . . . ,tₖ] (9);
where tₘ (m=1, 2, . . . , k) is a time point corresponding to an m-th extreme point or boundary point in the curve, and k is the total number of points.

$$\{ \begin{matrix}{d}_{m} = \vert {SoC}_{t , m + 1} - {SoC}_{t , m} \vert \\ {α}_{m} = {t}_{m} \\ {β}_{m} = {t}_{m + 1} \\ D = [ {d}_{1} , {d}_{2} , ⋯ , {d}_{k - 1} ] \\ A = [ {α}_{1} , {α}_{2} , ⋯ , {α}_{k - 1} ] \\ B = [ {β}_{1} , {β}_{2} , ⋯ , {β}_{k - 1} ]\end{matrix} ; \qquad ( 10 )$$

where dₘ (m=1, 2, . . . , k−1) is the size of the m-th mileage; αₘ and βₘ are the starting moment and the ending moment of the m-th mileage, respectively; SoC_{t,m} is an energy value of the curve SoC at the moment tₘ, SoC_{t,m+1} is an energy value of the curve SoC at the moment tₘ₊₁, D is a set of k−1 mileage data, A is a starting moment set with k−1 elements, and B is an ending moment set with k−1 elements.

2) Parameter extraction: three continuous mileages dₘ₁, dₘ₂ and dₘ₃ in the mileage vector D, i.e., the set of k−1 mileage data, are taken out in sequence, and following determination is made.

a): If the extraction conditions dₘ₂≤dₘ₁ and dₘ₂≤dₘ₃ are satisfied, it is indicated that a cycle process is extracted, which is denoted as dₘ₂≤dₘ₁, ζₙ (n=1, 2, . . . ), and the energy variation amplitude dₙ, the starting moment an and the ending moment βₙ of the cycle process ζₙ are calculated. Sₙ and αₙ′ can be obtained according to equation (11):

$$\{ \begin{matrix}{s}_{n} = {SoC}_{t , m 2 + 1} - {SoC}_{t , m 2} \\ {α}_{n}^{′} = {a}_{m 2}\end{matrix} . \qquad ( 11 )$$

In the above equation, when Sₙ>0, ζₙ is a cycle process of charging first and then discharging. When Sₙ≤0, ζₙ is a cycle process of discharging first and then charging. Subsequently, the starting moment and the ending moment are calculated.

b) If the extraction conditions dₘ₂≤dₘ₁ and dₘ₂≤dₘ₃ are not satisfied, on the basis of m₂ and m₃ mileages, a next mileage is read from the range vector D and subjected to the above determination until the last mileage is processed. Through the above operations, the energy change process curve SoCₜ can be divided into cycle process ζ₁ . . . ζₖ (k is the number of cycle processes), and the SoC change amplitude vector S, the starting moment vector A′ and the ending moment vector β′ shown in the equation (12) can be obtained.

$$\{ \begin{matrix}S = [ {s}_{1} , {s}_{2} , ⋯ , {s}_{k} ] \\ {A}^{′} = [ {α}_{1}^{′} , {α}_{2}^{′} , ⋯ , {α}_{k}^{′} ] \\ {B}^{′} = [ {β}_{1}^{′} , {β}_{2}^{′} , ⋯ , {β}_{k}^{′} ]\end{matrix} \qquad ( 12 )$$

Step S6: a mathematical model of the relationship between the mileage corresponding to each cycle process and the utility loss of the hybrid energy storage system in the predetermined time period is constructed.

In practical application, based on the SoC variation curve of the hybrid energy storage station and calculation of charging and discharging mileage, the mathematical model of the utility loss and the charging and discharging mileage is established.

As the cycle life of energy storage decreases with the increase of percentage of the charging and discharging mileages M, if the cycle life of an energy storage device at 0% of the charging and discharging mileages is used as the maximum value Nₘₐₓ of the cycle life of the energy storage device, N is the cycle life, and CI is the investment utility of hybrid energy storage, and the cycle life is consumed once every cycle, and a certain amount of investment utility C is consumed correspondingly, then the relationship between C and the cycle life is:

$$C = CI \cdot \frac{N}{{N}_{max}} . \qquad ( 13 )$$

The charging and discharging mileage M is defined as the SoC difference between two stages, which is related to the absolute value of the ratio of the charging and discharging power difference to the rated power.

$${N}_{a} = {a}_{1} {M}_{a}^{n} + {a}_{2} {M}_{a}^{n - 1} + ⋯ + {a}_{n - 1} {M}_{a} + {a}_{n} ; \qquad ( 14 )$$

$$M = \vert {SoC}_{t} - {SoC}_{t - 1} \vert = \vert \frac{{P}_{c , t} - {P}_{d , t}}{{P}_{e}} \vert ; \qquad ( 15 )$$

where Nₐ is the cycle life, and aₙ is the expression coefficient. The equation (14) is the relationship between the cycle life and the mileage. The equation (15) is the definition of mileage. The equation (13) is the relationship between the loss and the cycle life. The relationship between the mileage and the loss in equation (16) is obtained through the equation (13) and the equation (14). The relationship between the mileage and the loss is obtained from the equation (13) and the equation (14). Therefore, the loss of energy storage changes with M as shown in the equation (16).

$${C}_{a} = {a}_{1}^{′} {M}_{a}^{n} + {a}_{2}^{′} {M}_{a}^{n - 1} + ⋯ + {a}_{n - 1}^{′} {M}_{a} + {a}_{n}^{′} ; \qquad ( 16 )$$

where Cₐ is a cost loss, and aₙ′ is a parameter in the equation (16) which is transformed from a parameter in the equation (14).

Step S7: According to the mathematical model, the mileage of each energy storage in the corresponding cycle process in the hybrid energy storage system is calculated by using a principle of an equal consumed energy increase ratio.

In practical application, according to the relationship between the mileage and the loss, and referring to the principle of the equal consumed energy increase ratio of thermoelectric generating set, the equal mileage incremental utility ratio is put forward, that is, the mileage Mᵢ of each energy storage with optimal allocation can be obtained by calculating the partial derivatives of the mileage loss of different types of energy storage in different time periods and making the partial derivatives equal to each other.

Now, capacity allocation for n energy storages is described as an example, as shown in the equation (17).

$$\{ \begin{matrix}{C}_{a , 1} = {a}_{1}^{′} {M}_{a , 1}^{n} + {a}_{2}^{′} {M}_{a , 1}^{n - 1} + ⋯ + {a}_{n - 1}^{′} {M}_{a , 1} + {a}_{n}^{′} \\ {C}_{a , 2} = {b}_{1}^{′} {M}_{a , 2}^{n} + {b}_{2}^{′} {M}_{a , 2}^{n - 1} + ⋯ + {b}_{n - 1}^{′} {M}_{a , 2} + {b}_{n}^{′} \\ ⋯ \\ {C}_{a , n} = {k}_{1}^{′} {M}_{a , n}^{n} + {k}_{2}^{′} {M}_{a , n}^{n - 1} + ⋯ + {k}_{n - 1}^{′} {M}_{a , n} + {k}_{n}^{′}\end{matrix} ; \qquad ( 17 )$$

where C_{a,n} is a loss of the n-th energy storage in stage a, and M_{a,n}ⁿ is an n-th power of the mileage of the n-th energy storage in stage a. kₙ′ and bₙ′ are both coefficients and have n no physical significance.

On this basis, the equation (18) and the equation (19) are obtained.

$$\{ \begin{matrix}\frac{\partial {C}_{a , 1}}{\partial {M}_{1}} = n {a}_{1}^{′} {M}_{a , 1}^{n - 1} + ( n - 1 ) {a}_{2}^{′} {M}_{a , 1}^{n - 2} + ⋯ + {a}_{n - 1}^{′} = {λ}_{1} \\ \frac{\partial {C}_{a , 2}}{\partial {M}_{2}} = n {b}_{1}^{′} {M}_{a , 2}^{n - 1} + ( n - 1 ) {b}_{2}^{′} {M}_{a , 2}^{n - 2} + ⋯ + {b}_{n - 1}^{′} = {λ}_{2} \\ ⋯ \\ \frac{\partial {C}_{a , n}}{\partial {M}_{n}} = n {k}_{1}^{′} {M}_{a , n}^{n - 1} + ( n - 1 ) {k}_{2}^{′} {M}_{a , n}^{n - 2} + ⋯ + {k}_{n - 1}^{′} = {λ}_{n}\end{matrix} \qquad ( 18 )$$

$$\{ \begin{matrix}{λ}_{1} = {λ}_{2} = ⋯ = {λ}_{n} \\ {C}_{a} = {C}_{a , 1} + {C}_{a , 2} + ⋯ + {C}_{a , n}\end{matrix} \qquad ( 19 )$$

The equation (19) is an equation of multiple degree with multiple unknown, and can be solved to obtain the optimally allocation M_{a,n′}. Specifically, the optimal allocation obtained by solution is the mileage M_{a,1} of the first energy storage in the stage a, the mileage M_{a,2} of the second energy storage in the stage a, . . . , and the mileage M_{a,n} of the n-th energy storage in the stage a.

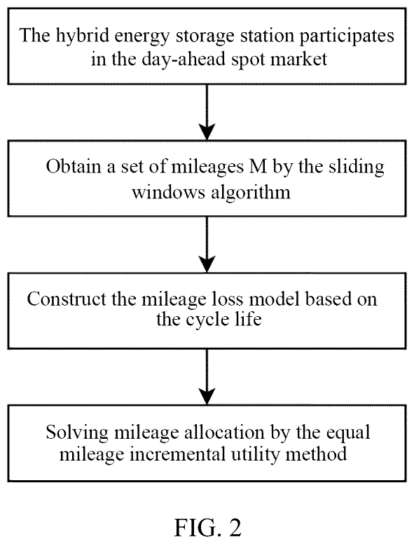

As shown in FIG. 2, the practical application process of the present disclosure is as follows: first, according to the demand of power services and the utility signal released by power services, the energy storage utility model is constructed to maximize the overall energy storage utility, and a charging and discharging situation and the SoC change curve of the hybrid energy storage station are determined.

Second, an appropriate mileage acquisition method is obtained by a mileage counting method, and the relationship between the loss utility and the mileage can also be determined according to the trend of the cycle life changing with mileages, thus constructing the mathematical model of energy storage mileage operation. Similarly to the equal consumed energy increase ratio, the equal mileage incremental utility ratio is put forward, and the theoretical principle of obtaining the optimal mileage allocation is determined.

Finally, the optimal mileage results of each energy storage are obtained by the mileage counting method, the mileage and loss equation, and the equal mileage incremental utility ratio method.

The present disclosure has the following advantages. (1) The present disclosure provides a theoretical principle of solving the optimal allocation problem of the energy storage system. Based on a principle of minimizing marginal utility, the principle of an equal mileage incremental utility method is introduced for power allocation of different types of energy storage in hybrid energy storage, which reduces the life loss of each type of energy storage and improves the overall efficiency.

(2) The present disclosure takes into account an idea of calculating the discharge depth by a traditional rain flow counting method. And, through the analogy to and the improvement on the idea, the mileage counting method is put forward and modelled to make it more convenient to express.

(3) The present disclosure constructs the relationship between the charging and discharging mileage and the utility with reasonable physical logic according to the correlation between the mileage of energy storage and the cycle life, and the correlation between the cycle life and the utility.

Embodiment 2: In order to implement the method corresponding to Embodiment 1 described above to achieve the corresponding functions and technical effects, a system for allocating hybrid energy storage capacity is provided hereinafter, which includes an acquisition module, a curve determining module, an extracting module, a first calculating module, a mileage determining module, a constructing module and a second calculating module.

The acquisition module is configured to acquire a power service utility signal.

The curve determining module is configured to determine a curve of the state of charge (SoC) of a hybrid energy storage system with respect to time with a maximum utility of the hybrid energy storage system in a predetermined time period as an objective function and with an SoC constraint and energy system (ES) charging and discharging constraints as constraint conditions and according to the power service utility signal.

The extracting module is configured to extract an SoC value and a time point corresponding to each extreme point in the curve of SoC of the hybrid energy storage system with respect to time to obtain a plurality of SoC values arranged in chronological order.

The first calculating module is configured to calculate a difference between adjacent SoC values to obtain a mileage sequence, where the mileage sequence includes a plurality of mileages; the mileages are arranged in chronological order.

The mileage determining module is configured to apply a sliding window algorithm according to the mileage sequence to obtain a plurality of cycle processes and a mileage corresponding to each cycle process, where each cycle process includes a continuous charging and a discharging process.

The constructing module is configured to construct a mathematical model of the relationship between the mileage corresponding to each cycle process and the utility loss of the hybrid energy storage system in the predetermined time period.

The second calculating module is configured to calculate the mileage of each energy storage of the hybrid energy storage system in the corresponding cycle process by applying a principle of an equal consumed energy increase ratio according to the mathematical model, and.

Embodiment 3: The present disclosure provides an electronic device, including a memory and a processor, wherein the memory is configured to store a computer program, and the processor executes the computer program to cause the electronic device to implement the method for allocating hybrid energy storage capacity described in Embodiment 1.

In an embodiment, the electronic device may be a server.

In addition, the embodiment of the present disclosure further provides a computer-readable storage medium, wherein a computer program is stored therein, which, when executed by a processor, implements the method for allocating hybrid energy storage capacity described in Embodiment 1.

In this specification, various embodiments are described in a progressive way. The differences between each embodiment and other embodiments are highlighted, and the same and similar parts of various embodiments can be referred to each other. Since the system provided in the embodiment corresponds to the method provided in the embodiment, the system is described simply. Refer to the description of the method for the relevant points.

In the present disclosure, specific examples are applied to illustrate the principle and implementation of the present disclosure, and the explanations of the above embodiments are only used to help understand the method and core ideas of the present disclosure. At the same time, according to the idea of the present disclosure, there will be some changes in the specific implementation and application scope for those skilled in the art. To sum up, the contents of the specification should not be construed as limiting the present disclosure.

What is claimed is:

1. A method for allocating hybrid energy storage capacity, comprising:
acquiring a power service utility signal;
determining a curve of a state of charge (SoC) of a hybrid energy storage system with respect to time with a maximum utility of the hybrid energy storage system in a predetermined time period as an objective function, with an SoC constraint and energy system (ES) charging and discharging constraints as constraint conditions and according to the power service utility signal;
extracting an SoC value and a time point corresponding to each extreme point in the curve of the SoC of the hybrid energy storage system with respect to time to obtain a plurality of SoC values arranged in chronological order;
calculating a difference between two adjacent SoC values as a mileage, to obtain a mileage sequence, wherein the mileage sequence comprises a plurality of mileages; the mileages are arranged in chronological order;
applying a sliding window algorithm according to the mileage sequence to obtain a plurality of cycle processes and a mileage of the hybrid energy storage system corresponding to each cycle process, wherein each cycle process comprises a continuous charging process and discharging process;
constructing a mathematical model of a relationship between the mileage of the hybrid energy storage system corresponding to each cycle process and an utility loss of the hybrid energy storage system in the predetermined time period;
calculating a mileage of each energy storage of the hybrid energy storage system in a corresponding cycle process by applying a principle of an equal consumed energy increase ratio according to the mathematical model;
controlling each energy storage to discharge or charge according to the mileage of each energy storage in the corresponding cycle process.

2. The method according to claim 1, wherein the predetermined time period is 24 hours.

3. The method according to claim 1, wherein applying a sliding window algorithm according to the mileage sequence to obtain a plurality of cycle processes and a mileage corresponding to each cycle process comprises:
determining whether a value of an intermediate element in a fixed-length sliding window is less than a value of each adjacent element of the intermediate element, wherein the fixed-length sliding window contains three elements;
when the value of the intermediate element is less than the value of each adjacent element of the intermediate element, a time point corresponding to the intermediate element is an ending moment of a cycle process, a time point corresponding to a first element in the fixed-length sliding window is a starting moment of the cycle process, and the value of the intermediate element is set as the mileage corresponding to the cycle process.

4. The method according to claim 1, wherein the objective function is:
$$max I = max {\sum }_{t = 1}^{24} {\sum }_{i = 1}^{n} {λ}_{i , t} ( {P}_{d , i , t} - {P}_{c , i , t} ) ;$$
the SoC constraint is:
$${SoC}_{min} \leq {SoC}_{t} \leq {SoC}_{max} ;$$
$${SoC}_{( 24 )} = {SoC}_{( 1 )} ;$$
the ES charging and discharging constraints are:
$${P}_{c min} \leq {P}_{c , t} \leq {P}_{c max} ;$$
$${P}_{d min} \leq {P}_{d , t} \leq {P}_{d max} ;$$
$$0 \leq {P}_{c , t} \leq {P}_{c max} \times {A}_{E} ;$$
$$0 \leq {P}_{d , t} \leq {P}_{d max} \times ( 1 - {A}_{E} ) ;$$
wherein SoC(t) is an SoC value of the energy storage system at moment t, SoC(1)=SoC(24) indicates that the SOC value of energy storage at a first moment in an operation day are equal to that at a last moment of the operation day; P_{c,t} is a discharging power of energy storage at moment t, P_{d,t} is a charging power of energy storage at moment t; P_{d,i,t} is a charging power of hybrid energy storage; P_{c,i,t} is a discharging power of hybrid energy storage; λ_{i,t} is a power service utility signal; SoCₘᵢₙ is a minimum value of the SoC; SoCₘₐₓ is a maximum value of the SoC; P_{c min} is a lower limit of the discharging power of the hybrid energy storage system; P_{c max} is an upper limit of the discharging power of the hybrid energy storage system; P_{d min} is a lower limit of the charging power of the hybrid energy storage system; P_{d max} is an upper limit of the charging power of the hybrid energy storage system; A_{E} is a binary variable; and I is an profit within 24 hours.

5. The method according to claim 1, wherein the mathematical model is:
$${C}_{a} = {a}_{1}^{′} {M}_{a}^{n} + {a}_{2}^{′} {M}_{a}^{n - 1} + ⋯ + {a}_{n - 1}^{′} {M}_{a} + {a}_{n}^{′} ;$$
wherein Cₐ is a cost loss, Mₐⁿ is an n-th power of a mileage in stage a₁′ . . . aₙ′ are all coefficient constants.

6. A system for allocating hybrid energy storage capacity, comprising:
an acquisition module, configured to acquire a power service utility signal;
a curve determining module, configured to determine a curve of a state of charge (SoC) of a hybrid energy storage system with respect to time with a maximum utility of the hybrid energy storage system in a predetermined time period as an objective function, with an SoC constraint and energy system (ES) charging and discharging constraints as constraint conditions and according to the power service utility signal;
an extracting module, configured to extract an SoC value and a time point corresponding to each extreme point in the curve of the SoC of the hybrid energy storage system with respect to time to obtain a plurality of SoC values arranged in chronological order;
a first calculating module, configured to calculate a difference between two adjacent SoC values as a mileage, to obtain a mileage sequence, wherein the mileage sequence comprises a plurality of mileages; the mileages are arranged in chronological order;
a mileage determining module, configured to apply a sliding window algorithm according to the mileage sequence to obtain a plurality of cycle processes and a mileage of the hybrid energy storage system corresponding to each cycle process, wherein each cycle process comprises a continuous charging process and discharging process;
a constructing module, configured to construct a mathematical model of a relationship between the mileage of the hybrid energy storage system corresponding to each cycle process and an utility loss of the hybrid energy storage system in the predetermined time period;
a second calculating module, configured to calculate a mileage of each energy storage of the hybrid energy storage system in a corresponding cycle process by applying a principle of an equal consumed energy increase ratio according to the mathematical model;
a control module, configured to controlling each energy storage to discharge or charge according to the mileage of each energy storage in the corresponding cycle process.

7. An electronic device, comprising a memory and a processor, wherein the memory is configured to store a computer program, and the processor executes the computer program to cause the electronic device to implement the method for allocating hybrid energy storage capacity according to claim 1.

8. The electronic device according to claim 7, wherein the predetermined time period is 24 hours.

9. The electronic device according to claim 7, wherein applying a sliding window algorithm according to the mileage sequence to obtain a plurality of cycle processes and a mileage corresponding to each cycle process comprises:
determining whether a value of an intermediate element in a fixed-length sliding window is less than a value of each adjacent element of the intermediate element, wherein the fixed-length sliding window contains three elements;
when the value of the intermediate element is less than the value of each adjacent element of the intermediate element, a time point corresponding to the intermediate element is an ending moment of a cycle process, a time point corresponding to a first element in the fixed-length sliding window is a starting moment of the cycle process, and the value of the intermediate element is set as the mileage corresponding to the cycle process.

10. The electronic device according to claim 7, wherein the objective function is:
$$max I = max {\sum }_{t = 1}^{24} {\sum }_{i = 1}^{n} {λ}_{i , t} ( {P}_{d , i , t} - {P}_{c , i , t} ) ;$$
the SoC constraint is:
$${SoC}_{min} \leq {SoC}_{t} \leq {SoC}_{max} ;$$
$${SoC}_{( 24 )} = {SoC}_{( 1 )} ;$$
the ES charging and discharging constraints are:
$${P}_{c min} \leq {P}_{c , t} \leq {P}_{c max} ;$$
$${P}_{d min} \leq {P}_{d , t} \leq {P}_{d max} ;$$
$$0 \leq {P}_{c , t} \leq {P}_{c max} \times {A}_{E} ;$$
$$0 \leq {P}_{d , t} \leq {P}_{d max} \times ( 1 \times {A}_{E} ) ;$$
wherein SoC(t) is an SoC value of the energy storage system at moment t, SoC(1)=SoC(24) indicates that the SOC value of energy storage at a first moment in an operation day are equal to that at a last moment of the operation day; P_{c,t} is a discharging power of energy storage at moment t, P_{d,t} is a charging power of energy storage at moment t; P_{d,i,t} is a charging power of hybrid energy storage; P_{c,i,t} is a discharging power of hybrid energy storage; λ_{i,t} is a power service utility signal; SoCₘᵢₙ is a minimum value of the SoC; SoCₘₐₓ is a maximum value of the SoC; P_{c min} is a lower limit of the discharging power of the hybrid energy storage system; P_{c max} is an upper limit of the discharging power of the hybrid energy storage system; P_{d min} is a lower limit of the charging power of the hybrid energy storage system; P_{d max} is an upper limit of the charging power of the hybrid energy storage system; A_{E} is a binary variable; and I is an profit within 24 hours.

11. The electronic device according to claim 7, wherein the mathematical model is:
$${C}_{a} = {a}_{1}^{′} {M}_{a}^{n} + {a}_{2}^{′} {M}_{a}^{n - 1} + ⋯ + {a}_{n - 1}^{′} {M}_{a} + {a}_{n}^{′} ;$$
wherein Cₐ is a cost loss, Mₐⁿ is an n-th power of a mileage in stage a; a₁′ . . . aₙ′ are all coefficient constants.

12. A non-transitory computer-readable storage medium, wherein a computer program is stored therein, which, when executed by a processor, implements the method for allocating hybrid energy storage capacity according to claim 1.

13. The non-transitory computer-readable storage medium according to claim 12, wherein the predetermined time period is 24 hours.

14. The non-transitory computer-readable storage medium according to claim 12, wherein applying a sliding window algorithm according to the mileage sequence to obtain a plurality of cycle processes and a mileage corresponding to each cycle process comprises:
determining whether a value of an intermediate element in a fixed-length sliding window is less than a value of each adjacent element of the intermediate element, wherein the fixed-length sliding window contains three elements;
when the value of the intermediate element is less than the value of each adjacent element of the intermediate element, a time point corresponding to the intermediate element is an ending moment of a cycle process, a time point corresponding to a first element in the fixed-length sliding window is a starting moment of the cycle process, and the value of the intermediate element is set as the mileage corresponding to the cycle process.

15. The non-transitory computer-readable storage medium according to claim 12, wherein the objective function is:
$$max I = max {\sum }_{t = 1}^{24} {\sum }_{i = 1}^{n} {λ}_{i , t} ( {P}_{d , i , t} - {P}_{c , i , t} ) ;$$
the SoC constraint is:
$${SoC}_{min} \leq {SoC}_{t} \leq {SoC}_{max} ;$$
$${SoC}_{( 24 )} = {SoC}_{( 1 )} ;$$
the ES charging and discharging constraints are:
$${P}_{c min} \leq {P}_{c , t} \leq {P}_{c max} ;$$
$${P}_{d min} \leq {P}_{d , t} \leq {P}_{d max} ;$$
$$0 \leq {P}_{c , t} \leq {P}_{c max} \times {A}_{E} ;$$
$$0 \leq {P}_{d , t} \leq {P}_{d max} \times ( 1 \times {A}_{E} ) ;$$
wherein SoC(t) is an SoC value of the energy storage system at moment t, SoC(1)=SoC(24) indicates that the SOC value of energy storage at a first moment in an operation day are equal to that at a last moment of the operation day; P_{c,t} is a discharging power of energy storage at moment t, P_{d,t} is a charging power of energy storage at moment t; P_{d,i,t} is a charging power of hybrid energy storage; P_{c,i,t} is a discharging power of hybrid energy storage; λ_{i,t} is a power service utility signal; SoCₘᵢₙ is a minimum value of the SoC; SoCₘₐₓ is a maximum value of the SoC; P_{c min} is a lower limit of the discharging power of the hybrid energy storage system; P_{c max} is an upper limit of the discharging power of the hybrid energy storage system; P_{d min} is a lower limit of the charging power of the hybrid energy storage system; P_{d max} is an upper limit of the charging power of the hybrid energy storage system; A_{E} is a binary variable; and I is an profit within 24 hours.

16. The non-transitory computer-readable storage medium according to claim 12, wherein the mathematical model is:
$${C}_{a} = {a}_{1}^{′} {M}_{a}^{n} + {a}_{2}^{′} {M}_{a}^{n - 1} + ⋯ + {a}_{n - 1}^{′} {M}_{a} + {a}_{n}^{′} ;$$
wherein Cₐ is a cost loss, Mₐⁿ is an n-th power of a mileage in stage a; a₁′ . . . aₙ′ are all coefficient constants.
